(19) United States
(12) Patent Application Publication
(10) Pub. No.: US 2024/0336337 A1
(43) Pub. Date: Oct. 10, 2024

(54) Method for Assembling Braces by Casting in an Offshore Support Structure for a Wind Turbine

(71) Applicant: Stiesdal Offshore A/S, Give (DK)

(72) Inventor: Henrik Stiesdal, Odense C (DK)

(21) Appl. No.: 18/746,517

(22) Filed: Jun. 18, 2024

Related U.S. Application Data
(63) Continuation of application No. PCT/DK2022/050265, filed on Dec. 6, 2022.

(30) Foreign Application Priority Data
Dec. 22, 2021 (DK) PA 2021 01260

(51) Int. Cl. B63B 75/00; B63B 21/50; B63B 35/44

(52) U.S. Cl. CPC B63B 75/00; B63B 21/50; B63B 35/44; B63B 2035/446

(57) ABSTRACT

In the assembly of an offshore support structure for a wind turbine, tubular braces are interconnected or connected to a tower support in cast connections where an end part of the corresponding brace is inserted into a sleeve that is fixed in the interconnecting brace or in the tower support, and the volume in between the sleeve and the end part of the inserted brace is filled by a casting material, typically grout.

### CROSS-REFERENCE TO RELATED APPLICATIONS

This application is a continuation under 35 U.S.C. 111 of International Patent Application No. PCT/DK2022/050265, filed Dec. 6, 2022, which claims the benefit of and priority to Danish Application No. PA 2021 01260, filed Dec. 22, 2021, each of which is hereby incorporated by reference in its entirety.

### FIELD OF INVENTION

The present invention relates to methods of assembly and optionally installation of an offshore support structure for a wind turbine.

### BACKGROUND

For offshore structures, for example for supporting wind turbines, tetrahedral structures advantageously provide a high degree of stability while, on a relative scale, requiring only moderate costs. In order to optimize production options, while at the same time reduce and minimize production costs, thereby making offshore wind energy parks increasingly attractive, there is a steady effort to find improvements in the production procedure.

Japanese patent application JP2000087504A discloses a method for providing an offshore tower structure where ends of connecting tubes are inserted through openings into larger braces, and a grout cast fills a portion of the larger brace and an end portion of the tube, which is provided with shear keys for additional stabilization.

The fact that grout is inserted in the entire tubular structure implies a large consumption of grout. It would be desirable to reduce the consumption of grout while safeguarding a high degree of stability and rigidity.

U.S. Pat. No. 4,245,928 discloses an offshore structure where piles are driven into the seabed and braces are fastened to the piles in order to provide stability. The braces are connected to the piles in joints that are fixed with cement.

WO2011/147472 discloses a segmented jacket construction, in particular for a foundation for a wind turbine installation, which comprises grid segments that are interconnected by joints that comprise tubular modules bonded by a grouted material.

When prior art grid segments are interconnected by grouted connections, the corresponding segment is pushed into the receiving cavity and grouted. This appears at first sight as a straightforward procedure. However, this is not so when the structures are very large, such as for offshore structures carrying modern large wind turbines. Especially, a mere opening in a tube does not give stability until grouted or at least until the opposite end is fixed. It would be desirable to obtain a better directional guidance when grid segments are inserted into cavities for grouted connections.

### BRIEF DESCRIPTION

It is an objective to provide an improved construction method for offshore platforms for wind turbines, in particular for tetrahedral structures. In particular, it is an objective to provide a construction method for offshore platforms, especially for wind turbines, in which grouted connections are provided at ends of tubular segments and which in a relatively simple way allows assembly with directional guidance as well as minimization of grout consumption. This objective and further advantages are achieved by a method of assembling and optionally also installing an offshore support structure for a wind turbine as described herein.

In short, in the assembly of an offshore support structure for a wind turbine, tubular braces are interconnected or connected to a tower support in cast connections where an end part of the corresponding brace is inserted into a sleeve that is fixed in the interconnecting brace or in the tower support, and the volume in between the sleeve and the end part of the inserted brace is filled by a casting material, typically grout.

Details are explained in the following.

For the assembly, a first set of a number of N, for example N=3, 4, 5 or 6, of first tubular braces and a second set of N second tubular braces are provided in addition to a tower support, which will be used for carrying a wind turbine tower. These components are then assembled into a support structure.

Although, the assembly method is particularly useful for an offshore support structure with an offshore wind turbine, the generality of the method does not exclude that it is used as a support structure for an offshore platform of another type, for example a floating platform.

For each pair of one of the first braces and one of the second braces, the second end part of the first brace is connected to a first part of the tower support at a first connection, and the second end part of the second tubular brace is connected to a second part of the tower support at a second connection. Further, the first end part of the second brace is connected to the first brace at a third connection. The second connection is above the first connection when the support structure is oriented for operation, where the wind turbine tower is in vertical orientation. Accordingly, the tower support, the first brace, and the second brace form a triangle in a vertical plane. Due to the triangular shape of the combination of the tower support, the radial brace, and the second brace, the second brace is also called a diagonal brace. The N pairs of braces are directed outwards from the tower support in different directions about a vertical central axis of the tower support. For this reason, the first braces are also called radial braces.

In the following, various specific embodiments are presented, in which cast, for example grouted, connections are used for interconnection between the braces and the tower support.

In a first embodiment, the second end of the first brace is fixed in the lower part of the tower support by a cast connection, advantageously a grouted connection. In particular, in this embodiment, the method comprises providing the first connections with a wall-opening in the first, lower part of the tower support and with a sleeve, made of steel, with a first sleeve-end and a second sleeve-end, wherein the first sleeve-end is welded to a rim of the opening in the tower support, which is also made of steel. The sleeve extends from the rim only inwards into an inner volume of the first part of the tower support but does not extend outwards from the rim beyond the opening. In other words, the sleeve is only inside the tower support and does not create an extremity that would be obstructive for transport and automated working of the outer surface of the tower support, for example painting of the surface. The second end part of the first brace is then inserted through the opening into the sleeve, and casting material, for example grout, is filled into a volume between the sleeve and the first brace and solidified for rigidly fixing the first brace inside the sleeve. Optionally, the second end part of the first brace is provided with a closed end, so that no casting material enters from the sleeve into an inner volume of the second end part of the first brace.

In a second embodiment, the second end of the second brace is fixed in the upper part of the tower support by a cast connection, advantageously a grouted connection. In particular, in this embodiment, the method comprises providing the second connections with a wall-opening in the second part of the tower support and a sleeve, made of steel, with a first sleeve-end and a second sleeve-end, wherein the first sleeve-end is welded to a rim of the opening in the tower support, which is also made of steel. The sleeve extends from the rim only inwards into an inner volume of the second part of the tower support but does not extend outwards from the rim beyond the opening. Also, in this embodiment, the sleeve is only inside the tower support and does not create an extremity that would be obstructive for transport and automated working of the outer surface of the tower support, for example painting of the surface. The second end part of the second brace is then inserted through the opening into the sleeve, and casting material, for example grout, is filled into a volume between the sleeve and the second brace and solidified for rigidly fixing the second brace in the sleeve. Optionally, the second end part of the second brace is provided with a closed end so that no casting material enters from the sleeve into an inner volume of the second end part of the second brace.

In a third embodiment, the first end of the second brace is fixed in the first brace by a cast connection, advantageously a grouted connection. In particular, in this embodiment, the method comprises providing the third connection with an opening in a wall of the first brace and a sleeve, made of steel, with a first sleeve-end and a second sleeve-end. The first sleeve-end is welded to a rim of the opening in the first brace, which is also made of steel, and wherein the sleeve extends from the rim of the opening in the first brace only inwards into an inner volume of the first brace but does not extend outwards from the rim beyond the opening in the first brace. In this embodiment, the sleeve is only inside the first brace and does not create an extremity that would be obstructive for transport and automated working of the outer surface of the first brace, for example painting of the surface. The first end part of the second brace is then inserted through the opening into the sleeve, and casting material, for example grout, is filled into a volume between the sleeve and the second brace and solidified for rigidly fixing the second brace in the sleeve. Optionally, the first end part of the second brace is provided with a closed end, so that no casting material enters from the sleeve into an inner volume of the first end part of the second brace.

As mentioned, the embodiments with the sleeve extending only inwards is particularly advantageous for transport and working, as described above. However, in some alternative cases, it may be acceptable to have the sleeve extending a small distance outwards. However, in useful practical embodiments, the sleeve should not extend more than 0.2 m outwards from the rim, as it otherwise may result in more difficult transport handling and working. It is pointed out that a typical diameter of a diagonal brace is in the range of 2 m so that 0.2 m is on the order of 10% of its diameter. An extension outwards from the rim by a distance corresponding to at most 10% of the diameter of the diagonal brace is another useful limit.

In some further embodiments, two of the above three embodiments or all three embodiments are combined.

In order to avoid using excessive amounts of casting material, especially grouting material, in the connection and to confine the casting material in the sleeve, the sleeve comprises a closed bottom at the second sleeve-end. For fixation, casting material, for example grout, is only filled into the volume inside the one-end closed sleeve but not outside the sleeve.

Advantageously, especially if the end parts of the braces are provided with closed ends, casting material, for example grout, is inserted into the volume between the outer side of the end part of the brace and the inner side of the sleeve only after insertion of the end part of the corresponding brace into the sleeve. This eases arrangement of the end part in the correct location inside the sleeve before the casting material is pressed into the void volume inside the sleeve.

The casting material is fluidic or semi-fluidic, for example polymer, concrete, or grout, which is then hardened to provide the solidified rigid casting. Grout is an exemplary material due to its high rigidity and longevity in saltwater. In the following, grout is exemplified as the casting material, but it could be substituted by another casting material, if it is more appropriate or useful.

Cavities formed by the sleeve are larger than the corresponding brace ends that they receive. This is not only advantageous in order to provide excess volume for sufficient grout inside the cavity between the brace end and the inner wall of the respective sleeve but also for allowing the braces to change angle slightly relative to the cavity during the assembly method for avoiding the brace getting stuck during insertion.

Typically, the sleeve is tubular with a central longitudinal axis parallel with a central longitudinal axis of the received tubular brace.

The sleeve is typically circular in cross section perpendicular to its central longitudinal axis, although, this is not strictly necessary. In some cases, the sleeve is polygonal, for example with a quadratic or rectangular cross section perpendicular to its central longitudinal axis.

For a seabed-fixed support structure, the rigid frame structure with tower support and N first braces and N second braces is typically sufficient for long term stability. For floating structures, such as Tension Leg Platforms (TLP) for wind turbine towers or semisubmersible platforms, it is desirable to provide additional stability. For this reason, as an option, the following extended embodiment is useful.

In this extended embodiment, a third set of N third braces, typically tubular braces, are provided for interconnecting the first braces by the third braces. For example, the third braces are connected to the first braces in a subsequent step, optionally by a grouted connection, or alternatively by welding or by connection to corresponding brackets. As braces are typically and generally made of steel, welding is one of the available options. Bolting the third braces to the first braces is another option, for example by first welding brackets to the braces, which are then used for the bolt connection.

For example, for N=4, the first braces form a cross with the tower support in the center, and the third braces stabilize the cross in the plane formed by the cross. Typically, the third set of N=4 braces form a square in which the first braces form the diagonals within. The first and third braces are optionally in a single plane. However, this is not strictly necessary. For example, the third braces form a square in one plane, and the first braces extend with their first end in the tower support out of such plane, for example below the plane of the square of the third braces. Furthermore, it is also not strictly necessary that the braces are equally long, and one or two of the first braces may be longer than the remaining two in order for the assembly of the N=4 third braces to deviate from a square and form a rectangle instead.

Another, typical example is for N=3, in which the third braces form a triangle, optionally with the tower in the center of the triangle. These third braces are also called side braces, as they form sides of a triangle. The first braces are also typically called radial braces, as they extend radially from the tower support to one of each of the corners in the triangle. Also, in this case, the first and third braces are optionally in a single horizontal plane. However, this is not strictly necessary. For example, the third braces may form a triangle in one plane, and the first braces may extend with their first end in the tower support out of such plane, for example below or above the horizontal plane of the triangle of the third braces. Furthermore, it is also not strictly necessary that the braces are equally long, forming an equilateral triangle, as the triangle need not necessarily be regular. Even further, it is possible that the tower support is not in the center of the triangle.

Optionally, the interconnection of the first braces by the third braces involves interconnecting the ends of the first braces by the third braces. However, this is not strictly necessary, as the connection can be a distance offset from the ends.

For the case N=3, the assembly may result in a tetrahedral structure formed by the first, second and third braces, optionally formed as a regular tetrahedron. In this case, the first braces are radial braces that extend radially from the tower support. The third braces are side braces, as they form sides of a triangle. The second braces are diagonal braces, as they extend diagonally from the first braces to the tower support, each second brace forming a vertical triangle with the first brace and the tower support.

For example, the tower support is centered in the tetrahedral structure. Alternatively, it is off-centered, or the tower support is provided in a corner of the super structure or along a side of a triangle between two nodes.

Once the offshore support structure has been assembled, typically onshore or on land, a wind turbine is mounted on top of the structure. The assembly is then moved to a point of destination offshore, typically dragged along by vessels, and then anchored to the seabed, for example while maintaining the structure floating. As mentioned, examples are TLP, which typically are floating under water, and semi-submersibles, which are floating half submersed in the water at the surface.

In order to optimize strength and longevity of the grout connections, shear keys are advantageously used on the inserted portion of the braces.

The first and second braces are tubular, and typically also the third braces are tubular.

Optionally, the tubular braces have volumes with positive buoyancy. Optionally, the volumes can be flooded for adjusting the buoyancy. In most general cases, the braces are straight.

As an example, braces optionally have a diameter in the range of 1 to 6 meters, the larger of which can be more than 50 meters long. Brace ends are optionally inserted a distance of 3 to 5 meters in the respective cavity.

Optionally, the tower support itself is tubular, for example cylindrical or conical or a combination thereof in adjacent sections of the tubular support structure.

### BRIEF DESCRIPTION OF THE DRAWINGS

The invention will be explained in more detail with reference to the drawings, where:

FIG. 1 discloses a tetrahedral structure for an offshore wind turbine, according to an embodiment;

FIG. 2 illustrates a connection between two braces, according to an embodiment;

FIG. 3 illustrates an alternative connection between two braces, according to an embodiment;

FIG. 4 is a perspective view of a sleeve in a section of a radial brace, according to an embodiment;

FIG. 5 is a perspective side view of a sleeve in a radial brace, according to an embodiment; and

FIG. 6 is a perspective side view of a sleeve in a tower support, according to an embodiment.

### DETAILED DESCRIPTION

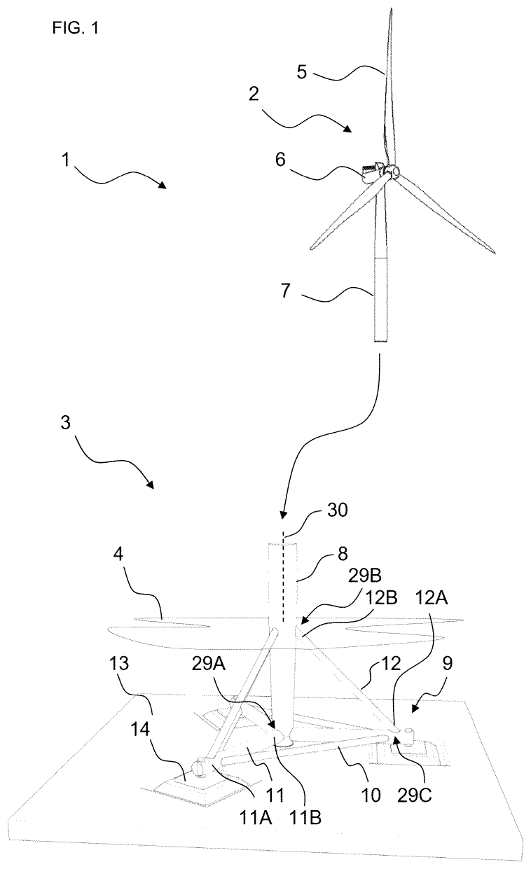

FIG. 1 illustrates an offshore wind turbine installation 1, according to an embodiment. The installation 1 comprises a wind turbine 2 and an offshore support structure 3 on which the wind turbine 2 is mounted for operation and by which it is supported in offshore conditions. The wind turbine 2 comprises a rotor 5 and a tower 7 and nacelle 6 that connects the rotor 5 with the tower 7. The offshore support structure 3 comprises a tower support 8, onto which the tower 7 of the wind turbine 2 is mounted. Notice that the wind turbine 2 is not to scale with the support structure 3 but is shown at smaller scale for ease of illustration.

The offshore support structure 3 is exemplified as a bottom supported structure with feet 14 embedded in the seabed 13 under the water surface 4. Such type of offshore support structure 3 is used in shallow waters. Typically, for deeper waters, floating structures are used, for example semisubmersible structures with mooring lines and buoyancy tanks that keep the structure 3 floating half-way submersed under water. In such case, the buoyancy tanks would be mounted at the nodes 9 of the structure 3 instead of the feet 14, unless the tubular structure itself provides sufficient buoyancy. Alternatively, the structure 3 could be a tension leg platform (TLP) with a fully submerged floating support structure. A floating support structure 3 would be held in its location by mooring lines that are fixed to the seabed 13.

The exemplified structure 3 has a tetrahedral shape with a central tower support 8. From a first, lower part of the tower support, first braces 11 extend radially outwards, so that these first braces 11 are also called radial braces 11. From a second, upper part of the tower support, second braces 12 extend to the first radial braces 11 so that the tower with each set of first brace 11 and second brace 12 forms a planar triangle. Due to the triangular shape of the tower support 8, the radial brace 11, and the second brace 12, the second brace is also called a diagonal brace 12.

The triangular base for the tetrahedron is formed by side braces 10 and the radial braces 11. The side braces 10 form a triangle by interconnection through the radial braces 11.

The radial braces 11 connect with their second ends 11B to a first, lower part of the tower support 8, and the diagonal braces 12 connect with their second ends 12B to a second, upper part of the tower support 8. The first end 12A of each of the diagonal braces 12 connect to one of the radial braces 11, typically at a location at or near the first end 11A of the corresponding radial brace 11.

The tower support 8 is exemplified as a support column but could have other shapes than illustrated. As illustrated, the tower support 8 extends to a position above the water surface 4, which is also typical for floating support structures.

As will be exemplified later in more detail, the connections between the braces 10, 11, 12 and the tower support 8 can be cast connections, for example grouted connections, where an end part 11A, 11B, 12B of a brace 11, 12 is accommodated in a cavity of another brace and/or in a cavity of the tower support 8, which is then filled with a casting material, typically grout, which is then hardened to provide a solidly fixed connection.

Examples of cast connections between the diagonal brace 12 and the radial brace 11 are described in more detail with reference to the corresponding illustrations in the following.

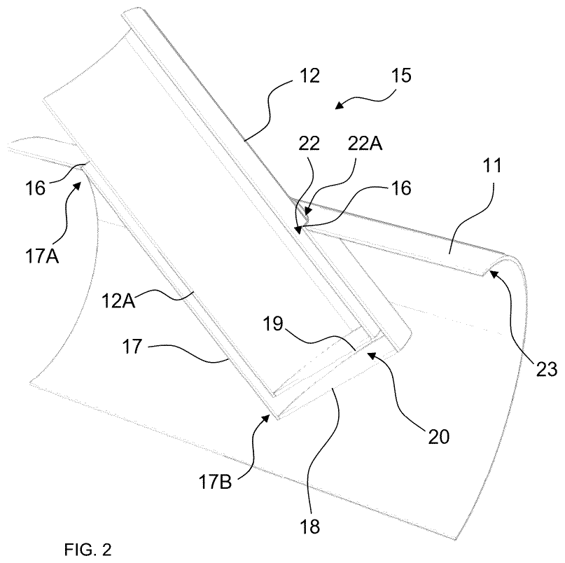

FIG. 2 illustrates a coaxial arrangement where a first end part 12A of diagonal brace 12 is inserted into a tubular sleeve 17 that is provided in the radial brace 11. The sleeve 17 has a first sleeve-end 17A and a second sleeve-end 17B, wherein the second sleeve-end 17B is closed by an end wall 18. In particular, the radial brace 11 is provided with an opening 22 in a wall 23 of the radial brace 11, and the first sleeve-end 17A, which is made of steel, is fastened by a weld 16 to a rim 22A of the opening 22 in the radial brace 11, which is also made of steel. For example, the weld 16 is made by a robot.

Notably, the sleeve 17 extends from the rim 22A only inwards into an inner volume of the first brace 11 and does not extend outwards from the rim 22A beyond the opening 22 in the first brace 11. This has some advantages when the large-sized radial braces 11 are transported because structural elements extending outwards from the surface of the radial braces 11 makes handling more difficult. Also, when the radial braces 11 are worked, especially when painted prior to assembly, it is advantageous that the braces 11 do not have extremities extending outwards.

When the first end part 12A of the diagonal brace 12 is inserted into the sleeve 17 through the opening 22, the sleeve 17 functions as a guide for the movement of the diagonal brace 12 and also defines the longitudinal direction of the diagonal brace 12. After insertion of the end part 12A of the diagonal brace 12 into the sleeve 17, casting material, typically grout, is inserted into the volume 20 of the void between the inner wall of the sleeve 17 and the outer wall of the end part 12A of the diagonal brace 12, after which the casting material is solidified for rigidly fixing the diagonal brace 12 in the sleeve 17.

In case the sleeve 17 would be open at the second end 17B, the casting material would also fill a portion of the interior volume of the radial brace 11. However, when the sleeve 17 has a closed bottom 18, as illustrated, the casting material, especially grout, that is inserted into the sleeve 17 is confined inside the volume 20 between the sleeve 17 and the end part 12A of the diagonal brace 12. This minimizes the volume of casting material needed for the fixation of the diagonal brace 12, which is an advantage.

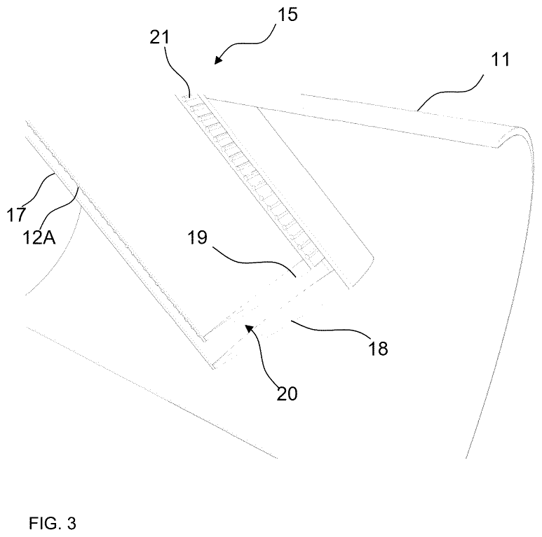

FIG. 3 illustrates an alternative embodiment in which the end part 12A of the diagonal brace 12 is provided with shear keys 21 for better longitudinal rigidity.

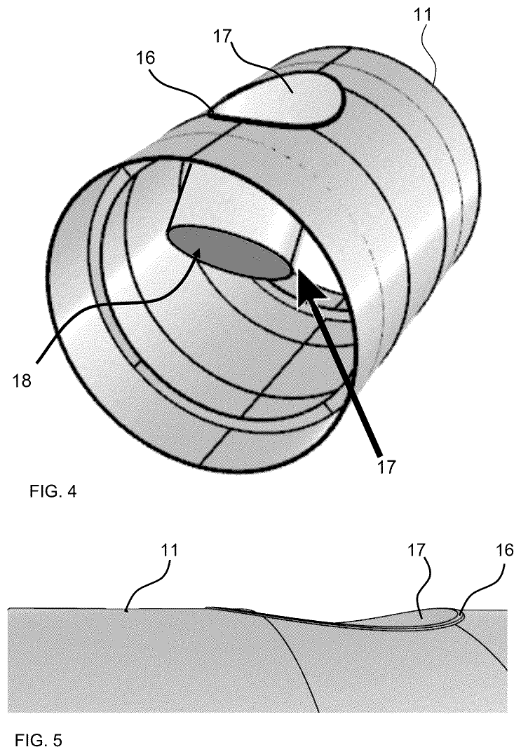

FIG. 4 is a perspective view into a section of the radial brace 11 with the sleeve having a closed bottom 18 so that casting material, especially grout, that is inserted into the sleeve 17 is confined, as explained above.

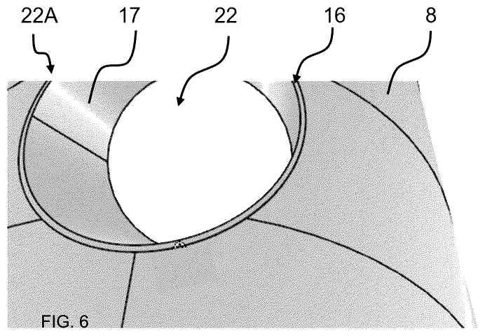

FIG. 5 shows that the sleeve does not extend outward from the outer surface of the radial brace 11. Only a slight elevation is experienced in certain cases by the weld 16, which however does not create any practical obstruction for transport of the radial brace 11 or working of the outer surface, especially when the outer surface is worked automatically by a robot, where the tubular brace is rotated on a working support.

FIG. 6 illustrates an alternative embodiment, in which an opening 22 surrounded by a sleeve 17 is provided in the tower support 8 for receiving a second end part 12B of a diagonal brace 12 or a second end part 11B of a radial brace 11. Also, in this case, the sleeve 17 would have a closed bottom. In order for the casting material not to run out of the volume 20 between the sleeve and the inserted brace 11, 12, a tightening gasket would be provided around the brace 11, 12 along the rim 22A of the opening 22 during filling of the sleeve 17 with the casting material and until the casting material has hardened. In some cases, the gasket would remain along the rim, in other cases, it would be removed again.

Although, the system has been exemplified for a triangular, especially, tetrahedral structure, it is also applicable for other polygonal structures, for example having 4, 5 or 6 radial braces 11 and a corresponding number of diagonal braces 12. As a typical option, in order to end with a structure as illustrated in FIG. 1, side braces 10 are connected to the radial braces 11, which enhances rigidity.

What is claimed is:

1. A method for assembling an offshore support structure for a wind turbine, the method comprising:
providing a tower support for carrying a wind turbine tower;
providing N first braces and N second braces, wherein N is an integer having a value of at least three, each brace having a first end part and a second end part;
wherein each of the braces has a longitudinal central axis;
for each pair of one of the first braces and one of the second braces, connecting the second end part of the first brace to a first part of the tower support at a first connection, connecting the second end part of the second brace to a second part of the tower support at a second connection, and connecting the first end part of the second brace to the first brace at a third connection, wherein the second part of the tower support and the second connection are above the first part of the tower support and the first connection when the support structure is oriented for offshore operation, and wherein the tower support, the first brace, and the second brace form a triangle in a vertical plane, and wherein the N pairs of braces are directed outwards from the tower support in different directions about a vertical central axis of the tower support;
wherein the method comprises at least one of A, B and C:
(A) providing the first connection with a wall-opening in the first part of the tower support and a sleeve with a first sleeve-end and a second sleeve-end, wherein the first sleeve-end is welded to a rim of the opening and wherein the sleeve extends from the rim inwards into an inner volume of the first part of the tower support, and wherein the sleeve extends no more than 0.2 m outwards from the rim;
inserting the second end part of the first brace through the opening into the sleeve;
filling casting material into a volume between the sleeve and the first brace; and
solidifying the casting material for rigidly fixing the first brace in the sleeve;
(B) providing the second connection with a wall-opening in the second part of the tower support and a sleeve with a first sleeve-end and a second sleeve-end, wherein the first sleeve-end is welded to a rim of the opening and wherein the sleeve extends from the rim inwards into an inner volume of the second part of the tower support, and wherein the sleeve extends no more than 0.2 m outwards from the rim;
inserting the second end part of the second brace through the opening into the sleeve;
filling casting material into a volume between the sleeve and the second brace; and
solidifying the casting material for rigidly fixing the second brace in the sleeve;
(C) providing the third connection with an opening in a wall of the first brace and a sleeve with a first sleeve-end and a second sleeve-end, wherein the first sleeve-end is welded to a rim of the opening and wherein the sleeve extends from the rim inwards into an inner volume of the first brace, and wherein the sleeve extends no more than 0.2 m outwards from the rim;
inserting the first end part of the second brace through the opening into the sleeve;
filling casting material into a volume between the sleeve and the second brace; and
solidifying the casting material for rigidly fixing the second brace in the sleeve.

2. The method according to claim 1, wherein the sleeve comprises a closed bottom at the second sleeve-end and the step of filling the casting material comprises constraining the casting material to the volume inside the sleeve.

3. The method according to claim 1, wherein the sleeve does not extend outwards from the rim beyond the opening.

4. The method according to claim 1, wherein the sleeve extends from the rim only inwards into the inner volume.

5. The method according to claim 1, further comprising:
in A, providing the second end part of the first brace with a closed end;
in B, providing the second end part of the second brace with a closed end;
in C, providing the first end part of the second brace with a closed end.

6. The method according to claim 1, wherein filling casting material occurs after insertion of the end part into the sleeve.

7. The method according to claim 1, further comprising providing a third set of N third braces and interconnecting the first braces with the third braces for increasing rigidity between the first braces.

8. The method according to claim 7, wherein N is 3, and wherein the third braces form a triangular structure.

9. The method according to claim 8, further comprising forming a tetrahedral structure by the first braces, the second braces and the third braces.

10. The method according to claim 9, further comprising forming the tetrahedral structure as a regular tetrahedron with the tower support centered in the tetrahedral structure.

11. The method according to claim 1, further comprising:
assembling the offshore support structure onshore;
providing a wind turbine on top of the support structure;
after assembling and hardening of the casting material in the sleeves, moving the offshore support structure to an offshore point of destination; and
anchoring the offshore support structure to a seabed.

12. The method according to claim 11, further comprising installing the offshore support structure in a floating structure.

13. The method according to claim 1, wherein the casting material is grout.
